(19) United States
(12) Patent Application Publication
(10) Pub. No.: US 2017/0330208 A1
(43) Pub. Date: Nov. 16, 2017

(54) CUSTOMER SERVICE MONITORING DEVICE, CUSTOMER SERVICE MONITORING SYSTEM, AND CUSTOMER SERVICE MONITORING METHOD

(71) Applicant: PANASONIC INTELLECTUAL PROPERTY MANAGEMENT CO., LTD., Osaka (JP)

(72) Inventor: Takeshi WAKAKO, Kanagawa (JP)

(73) Assignee: PANASONIC INTELLECTUAL PROPERTY MANAGEMENT CO., LTD., Osaka (JP)

(21) Appl. No.: 15/666,905

(22) Filed: Aug. 2, 2017

Related U.S. Application Data
(63) Continuation of application No. PCT/JP2015/002975, filed on Jun. 15, 2015.

(30) Foreign Application Priority Data
Mar. 20, 2015 (JP) 2015-058602

(51) Int. Cl. G06Q 30/02; G10L 25/63; G06K 9/00

(52) U.S. Cl. CPC G06Q 30/0201; G06K 9/00335; G10L 25/63

(57) ABSTRACT

A customer service monitoring device for monitoring customer service attitudes of customer service persons, based on voices when providing customer service is configured to include a voice input unit to which voices of conversations between the customer service persons and customer service partners thereof are input as voice signals, a voice data storage unit in which voice data based on each of the voice signals is stored by being linked with position data related to a position where each of the voices is acquired and time data related to time when each of the voices is acquired, and a voice data extractor which extracts voice data corresponding to a position and time designated by a user from the voice data stored in the voice data storage unit.

### TECHNICAL FIELD

The present invention relates to customer service monitoring device, a customer service monitoring system, and a customer service monitoring method, for monitoring customer service attitudes of service persons, based on voices when providing customer service.

### BACKGROUND ART

It is known that a good customer service attitude of an employee or the like leads to customer satisfaction and results in an increase of a customer collection rate or sales, in a service industry of retail, a hotel or the like It is common to perform an opinion survey or the like with respect to customers as a method of evaluating the customer service attitudes of an employee or the like, but the customer service evaluation method is performed by involving many people, and thus, it is inefficient and there is a problem that has poor objectivity.

Therefore, for example, a customer service data storage device is known which acquires conversations between a store clerk actually making a customer service and a customer and recognizes emotion of the store clerk and emotion of the customer, based on voices, thereby, calculating a degree of customer satisfaction (refer to Japanese Patent No. 5533219).

In addition, it is preferable that customer service evaluation based on the voice is performed for each customer who becomes a customer service target Therefore, for example, a customer service supporting device is known which detects changing of a target customer who is a customer service target of a store clerk, based on at least one voice included in conversations between the store clerk and a customer (refer to Japanese Patent Unexamined Publication No. 2011-237966).

However, in a case where a store clerk who serves one customer is frequently changed (for example, in a case where the customer makes an appropriate order or the like to different store clerks for each dish or each foodstuff thereof at a store which provides food in a self-service manner), a correspondence relationship (that is, a relationship in which a conversation is made) between the store clerk and the customer, or a position where the conversation is made in the store is also changed frequently, but even in the case, it is preferable that a conversation (voice data) of an evaluation target can be easily acquired Thereby, customer service attitudes of a plurality of store clerks who respond to one customer (or a customer service attitude with respect to a plurality of customers to whom one store clerk responds) can be easily monitored.

However, technologies of the related art described in the aforementioned Japanese Patent No. 5533219 and Japanese Patent Unexamined Publication No. 2011-237966 have a problem that the conversation between a desired store clerk and a customer is not easily extracted without assuming a case where a store clerk who serves one customer is frequently switched, in such a case.

### SUMMARY OF THE INVENTION

A customer service monitoring device according to the present invention is a customer service monitoring device for monitoring customer service attitudes of customer service persons, based on voices when providing customer service, and includes a voice input unit to which voices of conversations between the customer service persons and customer service partners thereof are input as voice signals, a voice data storage unit in which voice data based on each of the voice signals is stored by being linked with position data related to a position where each of the voices is acquired and time data related to time when each of the voices is acquired, and a voice data extractor which extracts voice data corresponding to a position and time designated by a user from the voice data stored in the voice data storage unit.

According to the present invention, it is possible to appropriately evaluate a customer service attitude of a person based on a voice of the person when providing customer service.

### BRIEF DESCRIPTION OF DRAWINGS

FIG. 1 is an entire configuration diagram of a customer service monitoring system according to an exemplary embodiment.

FIG. 2 is an explanatory view illustrating a first application example of the customer service monitoring system according to the exemplary embodiment.

FIG. 3 is a functional block diagram of the customer service monitoring system according to the exemplary embodiment.

FIG. 4 is a flowchart illustrating a flow of customer service person extraction processing performed by a customer service person extractor illustrated in FIG. 3.

FIG. 5 is a flowchart illustrating a flow of customer service partner extraction processing performed by a customer service partner extractor illustrated in FIG. 3.

FIG. 6 is a flowchart illustrating a flow of conversation partner determination processing performed by the customer service partner extractor illustrated in FIG. 3.

FIG. 7 is an explanatory diagram of person detection processing performed by the customer service person extractor and the customer service partner extractor.

FIG. 8 is an explanatory diagram of the person detection processing performed by the customer service person extractor and the customer service partner extractor.

FIG. 9 is a diagram illustrating an example of a customer service list generated by a customer service list generator.

FIG. 10 is a flowchart illustrating a flow of voice monitoring processing performed by a monitoring processor illustrated in FIG. 3.

FIG. 11A is an explanatory diagram of a designation method of a monitoring target in step ST401 in FIG. 10.

FIG. 11B is an explanatory diagram of the designation method of the monitoring target in step ST401 in FIG. 10.

FIG. 12A is an explanatory diagram illustrating a first modification example of the monitoring target designation method of FIG. 11.

FIG. 12B is an explanatory diagram illustrating the first modification example of the monitoring target designation method of FIG. 11.

FIG. 13 is an explanatory diagram illustrating a second modification example of the monitoring target designation method of FIG. 11.

FIG. 14 is an explanatory diagram illustrating a third modification example of the monitoring target designation method of FIG. 11.

FIG. 15 is an explanatory diagram illustrating a fourth modification example of the monitoring target designation method of FIG. 11.

FIG. 16 is an explanatory diagram illustrating a fifth modification example of the monitoring target designation method of FIG. 11.

FIG. 17A is an explanatory diagram illustrating a sixth modification example of the monitoring target designation method of FIG. 11.

FIG. 17B is an explanatory diagram illustrating the sixth modification example of the monitoring target designation method of FIG. 11.

FIG. 18A is an explanatory diagram illustrating a seventh modification example of the monitoring target designation method of FIG. 11.

FIG. 18B is an explanatory diagram illustrating the seventh modification example of the monitoring target designation method of FIG. 11.

FIG. 18C is an explanatory diagram illustrating the seventh modification example of the monitoring target designation method of FIG. 11.

FIG. 19 is an explanatory view illustrating a second application example of the customer service monitoring system according to the exemplary embodiment.

FIG. 20 is an explanatory view illustrating a third application example of the customer service monitoring system according to the exemplary embodiment.

### DESCRIPTION OF EMBODIMENTS

First invention is a customer service monitoring device for monitoring customer service attitudes of customer service persons, based on voices when providing customer service, and includes a voice input unit to which voices of conversations between the customer service persons and customer service partners thereof are input as voice signals, a voice data storage unit in which voice data based on each of the voice signals is stored by being linked with position data related to a position where each of the voices is acquired and time data related to time when each of the voices is acquired, and a voice data extractor which extracts voice data corresponding to a position and time designated by a user from the voice data stored in the voice data storage unit.

According to the customer service monitoring device of the first invention, voice data (that is, a voice of a monitoring target) related to the conversation when providing desired customer service is extracted based on a position and time in which the voice is acquired, and thus, even in a case where a correspondence relationship between customer service person and a customer service partner, or the position in which the conversation is made is changed, a conversation between a desired customer service person and the customer service partner can be easily monitored.

In addition, a second invention further includes an image input unit to which a captured image that is obtained by capturing a state of conversations between the customer service persons and the customer service partners is input as an image signal, an image data storage unit that stores captured-image data based on the image signal, a customer service person extractor that extracts the customer service persons from the captured image, and a customer service partner extractor that extracts the customer service partners from the capture image, in the first invention, in which the voice data extractor extracts voice data corresponding to a position related to at least one of the customer service persons or the customer service partners designated by the user, from the voice data stored in the voice data storage unit.

According to the customer service monitoring device of the second invention, voice data related to the conversation when providing desired customer service is extracted based on a position of a customer service person or a customer service partner, and thus, the conversation between the desired customer service person and the customer service partner can be easily monitored.

In addition, a third invention further includes an image output unit that outputs the captured image based on the captured-image data, in the second invention, in which each of the customer service persons or each of the customer service partners designated by the user is designated by the user from the captured image which is output by the image output unit.

According to the customer service monitoring device of the third invention, voice data related to a conversation when providing desired customer service is extracted based on a position of a customer service person or a customer service partner in a captured image, and thus, the conversation between the desired customer service person and the customer service partner can be easily monitored.

In addition, in a fourth invention, the customer service partner extractor acquires distances between the customer service persons extracted by the customer service person extractor and the customer service partners extracted from the captured image, respectively, and associates each of the customer service partners with any one of the customer service persons based on a magnitude of each of the distances, in the second or third invention.

According to the customer service monitoring device of the fourth invention, even in a case where a store clerk who serves one customer is frequently changed, a customer service person and a customer service partner are associated with each other based on a distance between the customer service partner and the customer service person, and thus, the conversation between a desired customer service person and the customer service partner can be easily monitored.

In addition, a fifth invention is a customer service monitoring system including a customer service monitoring device, a voice input device which inputs voices of conversations between the customer service persons and customer service partners thereof to the customer service monitoring device as voice signals, and an image input device which inputs a captured image which is obtained by capturing a state of conversations between the customer service persons and the customer service partners to the customer service monitoring device as an image signal.

In addition, a sixth invention is a customer service monitoring method for monitoring customer service attitudes of customer service persons, based on voices when providing customer service, and includes a voice inputting step of inputting voices of conversations between the customer service persons and customer service partners thereof as voice signals, a voice data storing step of storing voice data based on each of the voice signals to be linked with position data related to a position where each of the voices is acquired and time data related to time when each of the voices is acquired, and a voice data extracting step of extracting voice data corresponding to a position and time designated by a user from the voice data stored in the voice data storage unit.

Hereinafter, exemplary embodiments of the present invention will be described with reference to the drawings.

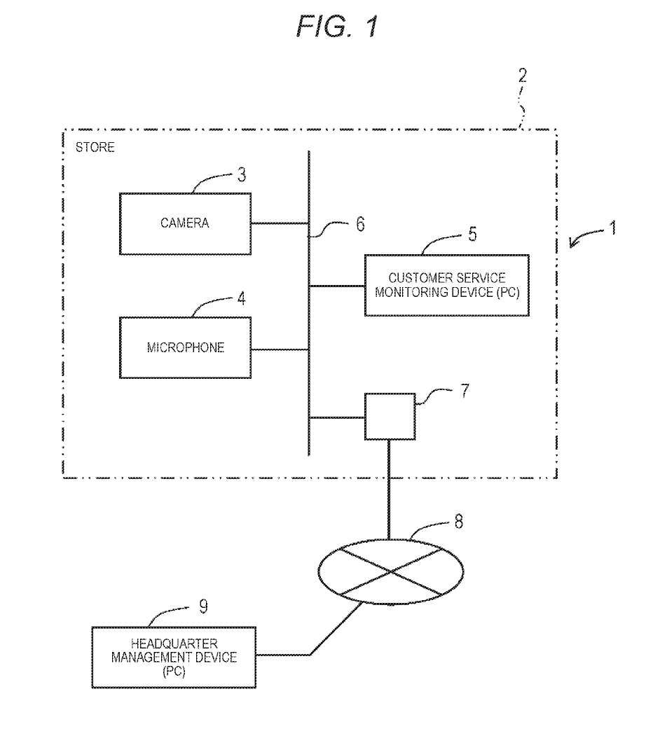

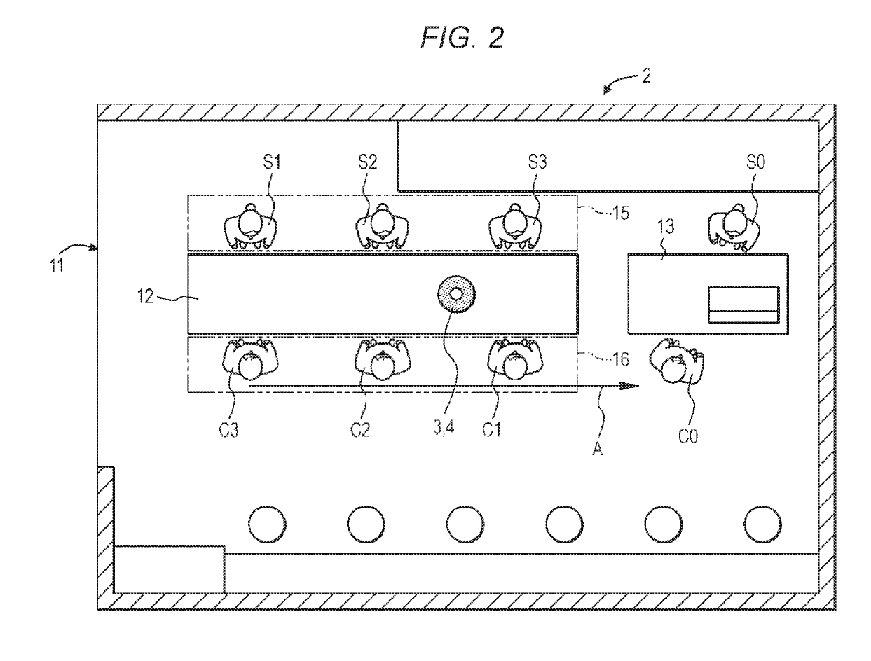

FIG. 1 is an entire configuration diagram of customer service monitoring system 1 according to an exemplary embodiment of the present invention, and FIG. 2 is an explanatory view illustrating a first application example of customer service monitoring system 1.

As illustrated in FIG. 1, customer service monitoring system 1 is built in store 2 or the like, and a customer service attitude of a customer service person (here, store clerk) with respect to a customer service partner (here, a customer visiting the store) can be monitored by a manager or the like (here, a manager of store 2) Camera (image input device) 3 for capturing an image of the interior of the store, microphone (voice input device) 4 for collecting voices in the store, and customer service monitoring device 5 for monitoring a customer service attitude of the store clerk based on a voice when providing customer service are provided in store 2, as configuration elements of customer service monitoring system 1 Customer service monitoring device 5 can also monitor the customer service attitude of the store clerk based on video in addition to the voice when providing customer service.

Camera 3 and microphone 4 can directly or indirectly communicate with customer service monitoring device 5 via communication line 6 such as the LAN (Local Area Network) In addition, in customer service monitoring system 1, camera 3, microphone 4, and customer service monitoring device 5 can communicate with headquarter management device 9 via wide area network 8 such as the Internet based on a public line or a dedicated line by relay device 7 provided in communication line 6.

In the present exemplary embodiment, food and drink are provided to the customer in a self-service manner in store 2 to which customer service monitoring system 1 is applied As illustrated in FIG. 2 (a plan view of the store), in store 2, customers (see customers C0-C3 in FIG. 2) who enter from entrance 11 order each merchandise (here, dish), receive each merchandise, and pay for each merchandise, while advancing a merchandise purchase path indicated by arrow A on the front side of sales counter 12 and register counter 13 Store clerks (see store clerks S1-S3 in FIG. 2) who receive an order for each merchandise and perform transaction calculation are arranged on the back side of sales counter 12, and a store clerk (see store clerk S0 in FIG. 2) whom a customer pays for the purchased each merchandise is disposed on the back side of register counter 13.

Generally the customers (see customers C1 to C3 in FIG. 2) order different store clerks (see store clerk S1-S3 in FIG. 2) desired merchandise and receive the desired merchandise from the different store clerks, for each merchandise, while moving the front side of sales counter 12 In addition, a customer (see customer C0 in FIG. 2) who finishes receiving merchandise moves to register counter 13 and pays the store clerk (see store clerk S0 in FIG. 2) for all the purchased merchandise There may be a case where one store clerk serves a customer while moving in the back side of the counter, such as at a time zone where the number of customers is small.

In an example illustrated in FIG. 2, customer service monitoring system 1 acquires voices in the conversations between store clerks S1-S3 and customers C1-C3 at the time of ordering and transacting each merchandise, thereby, monitoring the customer service attitude of store clerks S1-S3 at the time of sales However, customer service monitoring system 1 can acquire the voices in the conversations between store clerk S0 and customer C0 at the time of payment, and monitor the customer service attitude of a customer service person at the time of payment.

Camera 3 is a known omnidirectional network camera installed on the ceiling of the store, and continuously captures a state of the inside of the store including store clerks S0-S3 and customers C0-C3 The image captured by camera 3 is transmitted to customer service monitoring device 5 and headquarter management device 9 via communication line 6 as a video signal As long as camera 3 can capture an image of at least an operation of the store clerk or an operation of the customer who is served (including expression or the like of the face of the store clerk or the customer as necessary), a function, arrangement, quantity, and the like of the camera are not limited, and various modifications can be made for the camera For example, it is also possible to dispose each camera in a plurality of places according to the arrangement of each store clerk in the store.

Microphone 4 is a known omnidirectional network microphone installed on the ceiling of the store, and continuously acquires (collects voice) voices in the store including the voices in the conversations between store clerks S0-S3 and customers C0-C3 Microphone 4 is configured with a microphone array (not illustrated) having a plurality (for example, 16) of microphone elements Each microphone element is arranged at a predetermined angle in the circumferential direction, and different voices (here, collecting voices spread at an angle of 20°) can be collected by signal processing The voices collected by microphone 4 are transmitted to customer service monitoring device 5 and headquarter management device 9 via communication line 6 as a voice signal.

As long as at least the voice in the conversation between the store clerk and the customer can be collected, a function, arrangement, quantity, and the like of microphone 4 are not particularly limited, and various modifications can be made For example, in customer service monitoring system 1, it is also possible to adopt a configuration in which microphones are arranged in a plurality of places (sales counters 12, register counters 13, and the like) according to arrangement of each store clerk in the store, and a configuration in which each microphone is attached to clothes or the like of each of store clerks S1-S3 In addition, in the present exemplary embodiment, microphone 4 acquires voices of both store clerk S0-S3 and customers C0-C3, but the invention is not limited to this, and microphone 4 may be configured to acquire only the voice of either store clerks S0-S3 or customer C0-C3 (or, a part of the store clerks or the customers).

Customer service monitoring device 5 is installed in a back yard of store 2 and is a PC (Personal Computer) which is used by a user (such as a manager of store 2) As will be described below, customer service monitoring device 5 acquires an image from camera 3 and a voice from microphone 4, and performs voice monitoring processing for extracting the conversation between the store clerk and the customer which are desired from the acquired voice data.

Details are not illustrated, but customer service monitoring device 5 includes a hardware configuration including a CPU (Central Processing Unit) that collectively performs various types of information processing, control of a peripheral device, and the like, based on a predetermined control program, a RAM (Random Access Memory) that functions as a work area of the CPU, and the like, a ROM (Read Only Memory) that stores a control program executed by the CPU and data, a network interface that performs communication processing via a network, a monitor (image output device), a speaker, an input device, an HDD (Hard Disk Drive), and the like, and at least a part of various functions (voice monitoring processing and the like) of customer service monitoring device 5 which will be described in detail below can be realized, as the CPU executes a predetermined control program (voice monitoring program) Not only a PC but also other information processing devices (server or the like) capable of performing the same function can be used as customer service monitoring device 5 In addition, at least a part of the functions of customer service monitoring device 5 may be replaced with processing which is performed by other known hardware.

Headquarter management device 9 is a PC having the same configuration as the customer service monitoring device 5 and can perform the same processing as customer service monitoring device 5 Headquarter management device 9 is used by a headquarter manager who collectively manages a plurality of stores which are the same as store 2 It is also possible to provide a configuration in which headquarter management device 9 shares a part of the voice monitoring processing performed by customer service monitoring device 5.

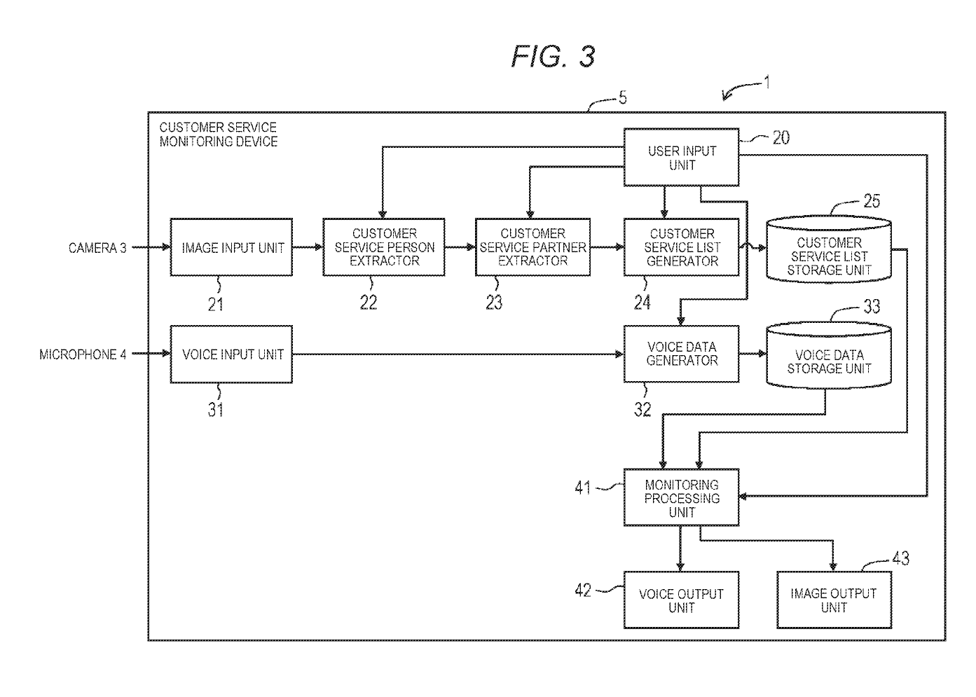

FIG. 3 is a functional block diagram of customer service monitoring system 1 according to the exemplary embodiment In customer service monitoring system 1, customer service monitoring device 5 includes user input unit 20 which inputs various types of settings or operation instructions provided by a user to each unit of the device, image input unit 21 which receives an image from camera 3 as an image signal, customer service person extractor 22 and customer service partner extractor 23 which respectively extract the store clerk and the customer by performing image processing of a plurality of temporally consecutive image frames (captured images) based on the input image signal, customer service list generator 24 which generates a customer service list indicating customer service situations (correspondence relationship and the like) of a store clerk for a customer, and customer service list storage unit 25 which stores the customer service list User input unit 20 is realized by known input devices (input devices such as a keyboard, a mouse, a touch panel, and the like).

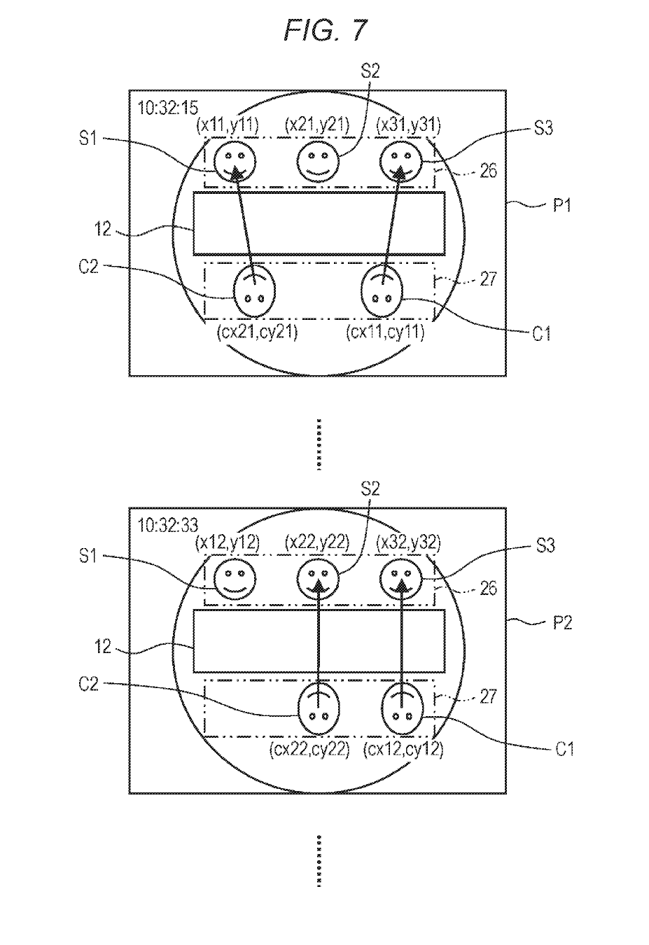

Customer service person extractor 22 performs person detection processing of detecting a person from each image frame by using a known person recognition technique In addition, customer service person extractor 22 performs tracking processing of tracking a person in a plurality of image frames by using a known person tracking technique with respect to the detected person As illustrated in FIG. 7 which will be described below, a user can set in advance store clerk area 26 (corresponding to movement range 15 of the store clerk in FIG. 2) in image frames P1 and P2 via user input unit 20, and thereby, customer service person extractor 22 extracts each person detected in store clerk area 26 of the image frame as a store clerk and tracks the store clerks.

In the same manner as customer service person extractor 22, customer service partner extractor 23 performs person detection processing and tracking processing As illustrated in FIG. 7 which will be described below, a user can preset customer area 27 (corresponding to movement range 16 of the customer in FIG. 2) of image frames P1 and P2 via user input unit 20, and thereby, customer service partner extractor 23 extracts each person detected in customer area 27 of the image frame as a customer and tracks the customers.

In addition, customer service partner extractor 23 determines whether or not there is a high possibility that a conversation is made between the customers extracted from each image frame and each store clerk, and associates one or more store clerks determined that there is a high possibility to make a conversation as a conversation partner More specifically, customer service partner extractor 23 calculates each distance between store clerks S1-S3 and the extracted customers, and associates the store clerk having the smallest distance as the conversation partner.

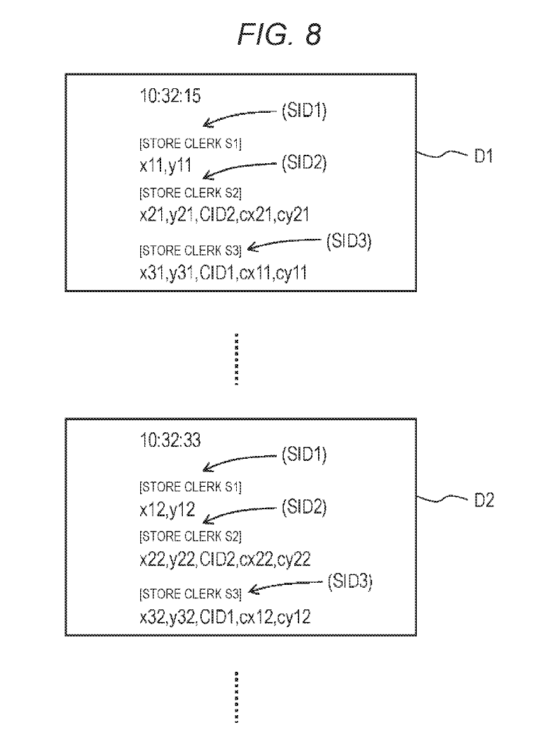

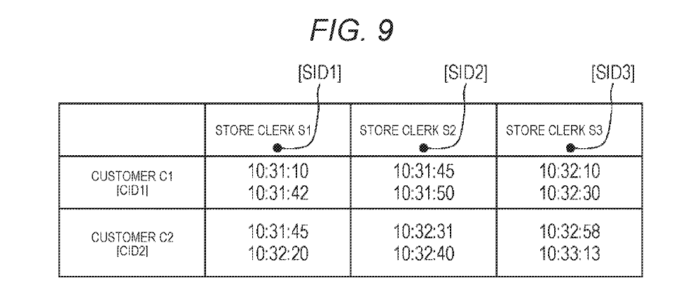

Customer service list generator 24 generates a customer service list (See FIG. 9 which will be described below) indicating time (that is, time for capturing an image) of a customer service with a high possibility of having a conversation with respect to each correspondence relationship (relationship of the conversation partner) between the store clerk and the customer, with respect to each image frame, based on results (refer to person detection data D1 and D2 illustrated in FIG. 8 which will be described below) of the person detection processing performed by customer service person extractor 22 and customer service partner extractor 23 The generated customer service list is stored in customer service list storage unit 25 Images captured at corresponding capturing times are linked with customer service times (here, customer service start time and customer service end time) in the customer service list, and data of the captured images are stored in customer service list storage unit (image data storage unit) 25 together with data of the customer service list.

In addition, customer service monitoring device 5 includes voice input unit 31 to which a voice is input from microphone 4 as a voice signal, voice data generator 32 which generates voice data based on the input voice signal, and voice data storage unit 33 which store the voice data Voice data generator 32 can store only the voice data based on the voice of the store clerk or the customer with voice intensity equal to or higher than a predetermined (threshold) in voice data storage unit 33, based on a preset threshold of voice intensity (voice pressure level) In addition, the voice data stored in voice data storage unit 33 is linked with position data on a position (for example, an area where a voice of the microphone is collected or a position where the microphone is installed) where the voice is acquired and time data on time when the voice is acquired, and is stored.

Furthermore, customer service monitoring device 5 includes monitoring processor (voice data extractor) 41 which extracts a voice and captured images of desired store clerks and customers from the voice data stored in voice data storage unit 33, voice output unit 42 which outputs the voice extracted by monitoring processor 41, and image output unit 43 which outputs the captured image extracted by monitoring processor 41.

A position and time designated by a user are input to monitoring processor 41 via user input unit 20, and monitoring processor 41 extracts the voice data corresponding to the designated position and time from the voice data stored in voice data storage unit 33 Voice output unit 42 is realized by a known voice output device such as a speaker In addition, image output unit 43 is realized by a known image output device such as a liquid crystal monitor.

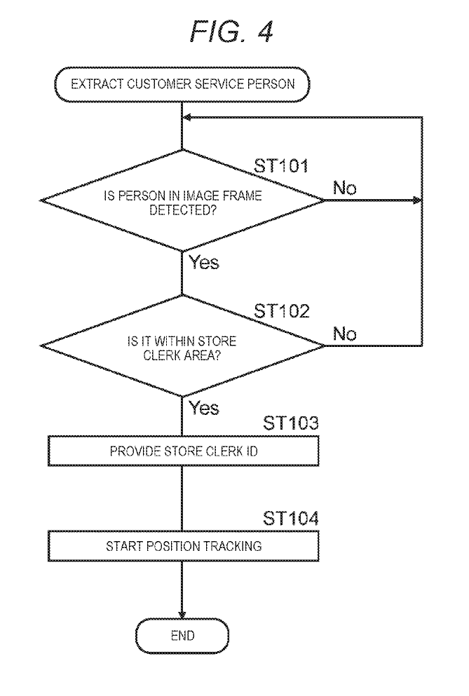

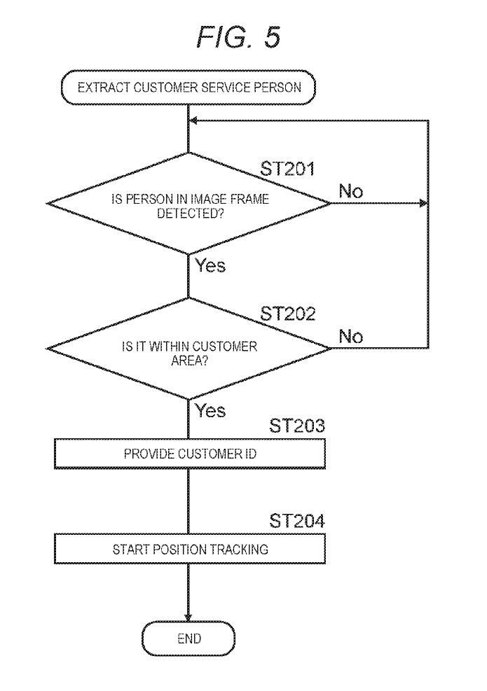

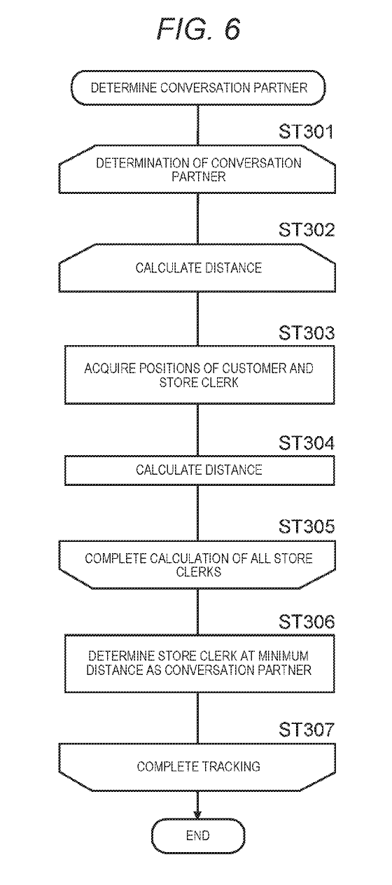

FIG. 4 is a flowchart illustrating a flow of customer service person extraction processing performed by customer service person extractor 22, FIG. 5 is a flowchart illustrating a flow of customer service partner extraction processing performed by customer service partner extractor 23, FIG. 6 is a flowchart illustrating a flow of conversation partner determination processing performed by the customer service partner extractor, FIG. 7 is an explanatory diagram of person detection processing performed by customer service person extractor 22 and customer service partner extractor 23, FIG. 8 is an explanatory diagram illustrating results of the person detection processing, and FIG. 9 is a diagram illustrating an example of the customer service list generated by the customer service list generator.

As illustrated in FIG. 4, first, if a person is detected from the image frame (ST101: Yes) during the customer service person extraction processing performed by customer service person extractor 22, it is determined whether or not a position (for example, a centroid position of the person image) where the person is detected is located within store clerk area 26 (see FIG. 7) (ST 102) In step ST102, if it is determined that the position where the person is detected is within store clerk area 26 (Yes), a store clerk ID (identification symbol) is given to the detected person (ST103), and tracking processing in store clerk area 26 starts for the store clerk (ST104).

As illustrated in FIG. 5, first, if a person is detected in the image frame (ST201: Yes) during the customer service partner extraction processing performed by customer service partner extractor 23, it is determined whether or not a position (for example, a centroid position of the person image) where a person is detected is located within customer area 27 (see FIG. 7) (ST202) In step ST202, if it is determined that the position where the person is detected is within store clerk area 26 (Yes), a customer ID (identification number) is given to the detected person (ST203), and tracking processing in customer area 27 starts for the customer (ST204).

As illustrated in FIG. 6, determination of a conversation partner of a customer of a processing target starts (ST 301) during the conversation partner determination processing performed by customer service partner extractor 23 In the determination of the conversation partner, calculation of distances between the customer of the processing target and all the store clerks is performed (ST 302) In the calculation of the distances, positions (coordinates) of the customer of the processing target and all the store clerks are first acquired based on results of the tracking processing of the customer in customer area 27 and the tracking processing of the store clerks in store clerk area 26 (ST303), and subsequently, the distances between the customer of the processing target and each store clerk are sequentially calculated based on the coordinates (ST304) The distance calculation is performed until the calculation of the distances between the customer of the processing target and all the store clerks are finally completed (ST305).

Therefore, if the calculation of the distances between the customer of the processing target and all store clerks is completed, a store clerk located at a minimum distance which is calculated is determined as a conversation partner of the customer of the processing target (ST306) The determinations of the conversation partner are sequentially performed for each image frame until tracking of the customer of the processing target is finally completed (for example, the customer of the processing target moves out of customer area 27).

In the aforementioned conversation partner determination processing, it is not necessary to associate the store clerk located at the smallest distance to the customer as a conversation partner, and for example, after step ST306, a step of determining whether or not the distance is equal to or longer than a predetermined threshold (the customer and the store clerk are separated from each other by a certain distance or more) is further provided, if the distance is equal to or longer than the predetermined threshold, it is also possible to provide a configuration in which the store clerk is not associated (determination is cancelled in step ST306) as a conversation partner.

Here, FIG. 7 schematically illustrates image frames P1 and P2 obtained by capturing store 2 illustrated in FIG. 2 by using camera 3 Image frame P1 is captured at 10:32:15 on a predetermined image-capturing date, and includes three store clerks S1-S3 and two customers C1 and C2 Positions of store clerks S1-S3 are respectively determined as coordinates (x11, y11), (x21, y21), and (x31, y31) by the customer service person extraction processing (see FIG. 4) of aforementioned customer service person extractor 22 In addition, positions of customers C1 and C2 are respectively determined as coordinates (cx11, cy11) and (cx21, cy21) by the customer service partner extraction processing (see FIG. 5) of aforementioned customer service partner extractor 23 Furthermore, the distances between the customer and the store clerks of image frame P1 are calculated by the conversation partner determination processing (see FIG. 6) of aforementioned customer service partner extractor 23, based on the respective coordinates, and as a result, store clerk S3 is associated with customer C1 as a conversation partner, and store clerk S1 is associated with customer C2 as a conversation partner (refer to arrows in FIG. 7).

Image frame P2 is captured at 10:32:33 on the same day as image frame P1, and includes three store clerks S1-S3 and two customers C1 and C2 Positions of store clerks S1-S3 are respectively set to coordinates (x12, y12), (x22, y22), and (x32, y32) by the customer service person extraction processing (see FIG. 4) of aforementioned customer service person extractor 22 In addition, positions of customers C1 and C2 are respectively set to coordinates (cx12, cy12) and (cx22, cy22) by the customer service partner extraction processing (see FIG. 5) of aforementioned customer service partner extractor 23 Furthermore, in the same manner as image frame P1, store clerk S3 is associated with customer C1 as a conversation partner, and store clerk S2 is associated with customer C2 as a conversation partner, by the conversation partner determination processing (see FIG. 6) of aforementioned customer service partner extractor 23.

In addition, FIG. 8 illustrates person detection data D1 and D2 generated by the person detection processing of customer service person extractor 22 and customer service partner extractor 23 for image frames P1 and P2 illustrated in FIG. 7, respectively Person detection data D1 includes identification symbols SID1, SID2, and SID3 indicating store clerk IDs of respective store clerks S1 to S3 and coordinates (x11, y11), (x21, y21), and (x31, y31) indicating positions of respective store clerks S1 to S3 In addition, person detection data D1 includes identification symbol CID2 of customer C2 who becomes the conversation partner of store clerk S2 and coordinates (cx21, cy21) indicating the position of customer C2, and furthermore, includes an identification symbol CID1 of customer C1 which becomes the conversation partner of store clerk S3 and coordinates (cx11, cy11) indicating the position of customer C1.

Person detection data D2 includes coordinates (x12, y12), (x22, y22), and (x32, y32) respectively indicating the positions of store clerks S1 to S3 In addition, person detection data D2 includes identification symbol CID2 of customer C2 which becomes the conversation partner and coordinates (cx22, cy22) indicating the position of customer C2, with respect to store clerk S2, and furthermore, includes identification symbol CID1 of customer C1 which becomes the conversation partner and coordinates (cx12, cy12) indicating the position of customer C1, with respect to store clerk S3 FIG. 8 illustrates only two person detection data D1 and D2, but in fact, person detection data can be generated for each image frame.

In addition, FIG. 9 illustrates a customer service list generated based on the person detection data as illustrated in FIG. 8 The customer service list includes information on customer service start time (an upper stage of a column indicating time) and customer service end time (a lower stage of the column indicating time) for respective customers C1 and C2 of respective store clerks S1-S3 Here, for example, the customer service start time can be time when one store clerk is associated with one customer in the image frame as a conversation partner In addition, for example, the customer service end time can be time when one of the customers or the store clerks associated as the conversation partner is newly associated with another store clerk or customer, or time when tracking the customer or the store clerk associated as the conversation partner is completed Alternatively, the customer service end time may be time when the distance between the customer and the store clerk is equal to or longer than the predetermined threshold.

FIG. 9 illustrates, for example, that store clerk S1 starts customer service for customer C1 at 10:31:10 (that is, store clerk S1 and customer C1 are associated with each other as the conversation partner) and ends the customer service for customer C1 at 10:31:42 (that is, a relationship between store clerk S1 and customer C1 as the conversation partner ends) In addition, after the customer service for customer C1 which is performed by store clerk S1 ends at 10:31:42, the customer service for customer C1 which is performed by store clerk S2 starts at 10:31:45 It indicates that, after the customer service for customer C1 which is performed by store clerk S2 ends at 10:31:50, furthermore, the customer service performed by store clerk S3 starts at 10:32:10, and the customer receives the customer service of store clerk S3 until 10:32:30.

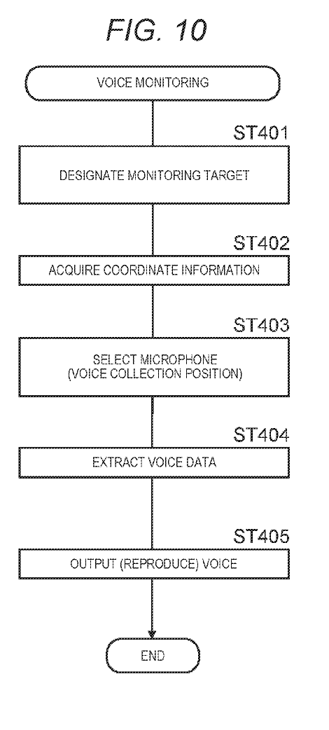

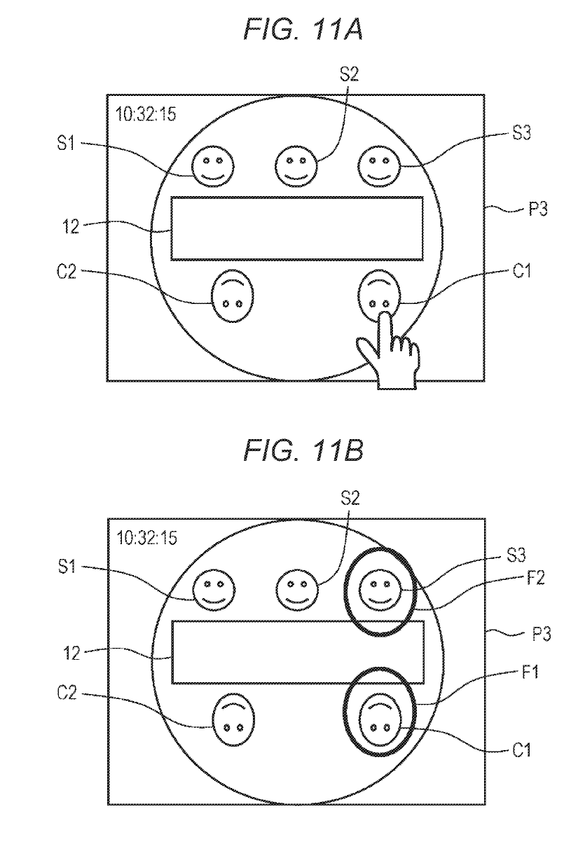

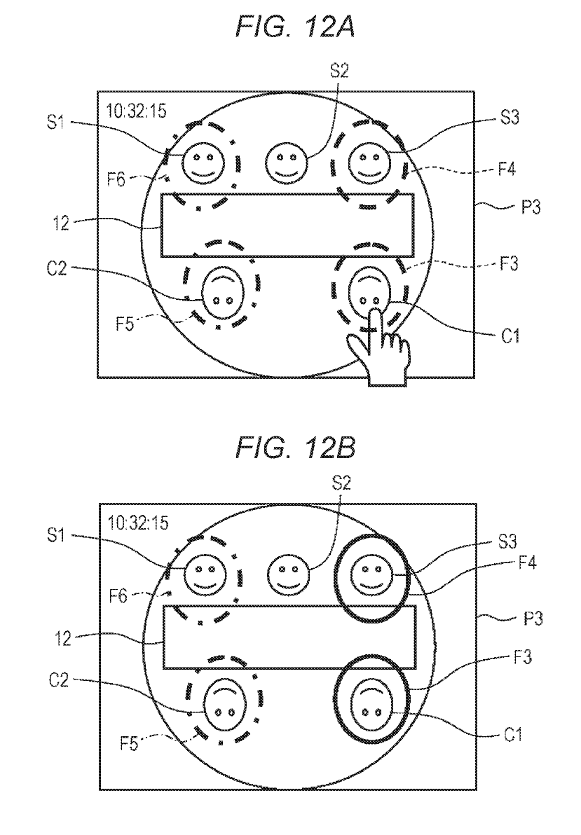

FIG. 10 is a flowchart illustrating a flow of the voice monitoring processing performed by monitoring processor 41, FIG. 11 is an explanatory diagram of a method of designating a monitoring target in step ST401 in FIG. 10, and FIG. 12 to FIG. 18 are respectively explanatory diagrams illustrating first to seventh modification examples of the method of designating the monitoring target in FIG. 11.

As illustrated in FIG. 10, the monitoring target is first designated by a user during the voice monitoring processing (ST401) More specifically the user designates a position (here, a position of a store clerk or a customer who makes the acquired voice) of the monitoring target and time (time when the voice is made) of the conversation Monitoring processor 41 acquires information on coordinates corresponding to a position designated by the user (ST402), and selects a microphone (or voice collection area thereof) closest to the position designated by the user, based on the coordinates thereof (ST403) Subsequently, monitoring processor 41 extracts voice data based on the voice acquired by the microphone selected in step ST403 and voice data corresponding to the time designated by a user from the voice data stored in voice data storage unit 33 (ST404) Therefore, monitoring processor 41 reproduces the extracted voice data and outputs the voice data from voice output unit 42 (ST405).

In step ST401, for example, as illustrated in FIG. 11A, the user selects customer C 1 in image frame P3 displayed on a monitor, a touch panel, or the like by image output unit 43, and thereby, a position of the monitoring target (here, customer C1 who makes voice) and time (here, corresponds to image-capturing time displayed at the upper right of the image frame) of the conversation can be designated In this case, monitoring processor 41 can emphatically display designated customer C1 and store clerk S3 who is a conversation partner thereof by enclosing them with figures (here, circles F1 and F2), such that the user can easily confirm the designated monitoring target, for example, as illustrated in FIG. 11B.

In addition, when the position of the monitoring target and the time of the conversation are designated, the user can emphatically display customer C1 and store clerk S3, and customer C2 and store clerk (S1), which are associated as a conversation partner, by enclosing them with figures of the same type (here, circles F3 and F4 of dashed lines and circles F5 and F6 of one-dotted line) respectively for example, as illustrated in FIG. 12A Thereby, the user can easily designate the position of the monitoring target and the time of the conversation, while easily grasping a customer of interest or a conversation partner of the store clerk In this case, monitoring processor 41 can display designated customer C1 and store clerk S3 who is the conversation partner thereof by changing (here, the type of lines of circles F3 and F4 is changed from a dashed line to a solid line) a type of the figures (here, circles F3 and F4 of dashed lines), such that the user can easily confirm the designated monitoring target, for example, as illustrated in FIG. 12B

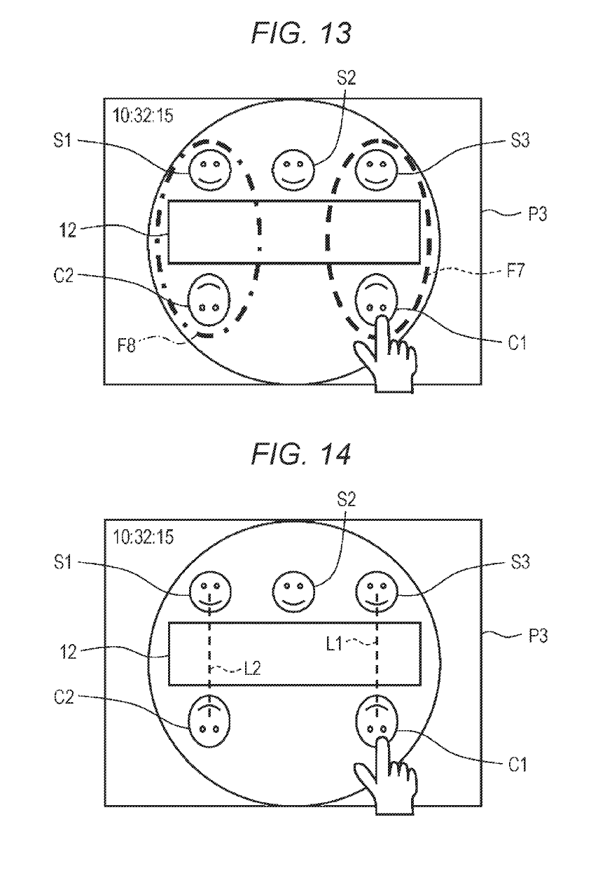

The emphatic display for associating the conversation partner illustrated in FIG. 11 and FIG. 12 may be performed by collectively enclosing customer C1 and store clerk S3, and customer C2 and store clerk S1 by using a dashed ellipse F7 and one-dotted line F8, respectively, for example, as illustrated in FIG. 13 Alternatively, the emphatic display may be performed by connecting customer C1 and store clerk S3, and customer C2 and store clerk S1 by using dotted lines L1 and L2, respectively, as illustrated in FIG. 14.

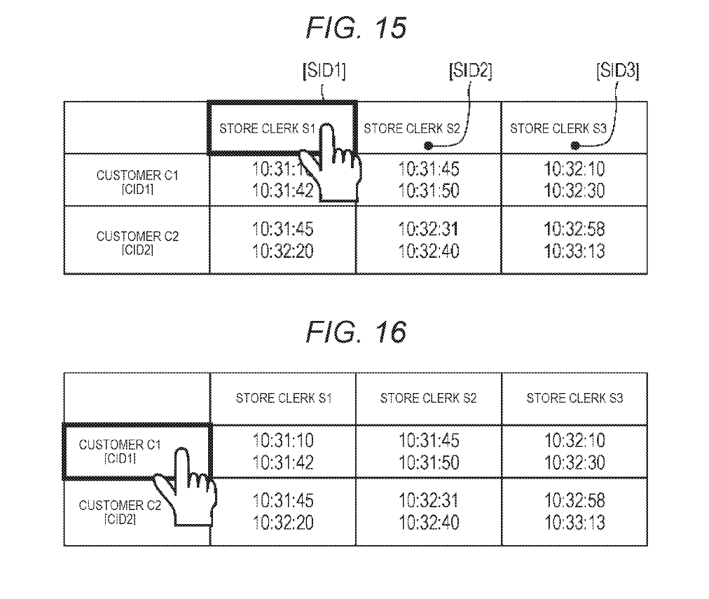

In step ST401, the user can also designate the monitoring target by selecting a predetermined column (here, store clerk S1 column) of the customer service list displayed on a monitor, a touch panel, or the like, for example, as illustrated in FIG. 15 In this case, by selecting store clerk S1 column of the user, conversations of customer C1 and customer C2 with respect to store clerk S1 are selected in the order of time and are sequentially output from voice output unit 42 For example, the customer service start time and the customer service end time for customer C1 in the customer service list are linked with a corresponding image frame, and customer service monitoring device 5 can extract voice data corresponding to the position of the monitoring target and the time of the conversation which are designated by the user from voice data storage unit 33, based on the information from the image frames By designating one store clerk with such a configuration, the voice of one store clerk when providing customer service to a plurality of customers can be collectively extracted, and as a result, a customer service attitude of one store clerk for a plurality of customers can be easily evaluated.

In addition, as illustrated in FIG. 16, the user can also designate a monitoring target by selecting customer C1 column of the customer service list In this case, by selecting customer C1 column of the user, conversations of store clerk S1, store clerk S2, and store clerk S3 with customer C1 are selected in order of time, and are sequentially output from voice output unit 42 By designating one customer with such a configuration, voices of a plurality of store clerks when providing customer service to the customer can be continuously extracted, and as a result, customer service attitudes of the plurality of store clerks for one customer can be easily evaluated.

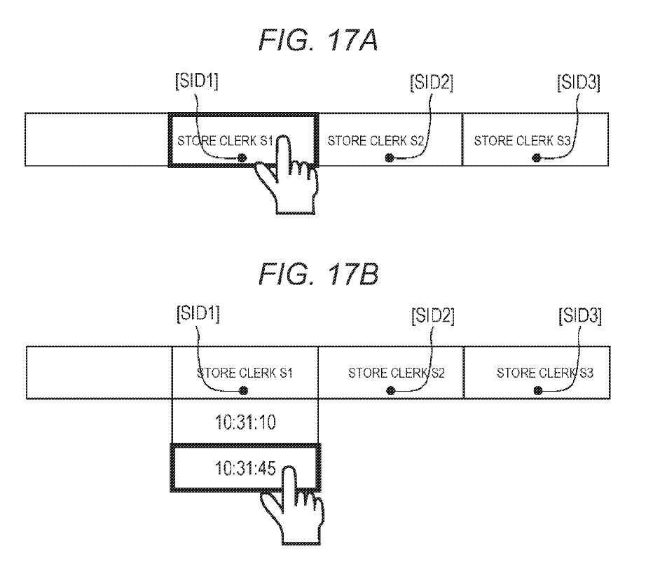

In addition, in step ST 401, the monitoring target can be designated as the user selects (here, selects store clerk S1 button) a store clerk selection button displayed on a monitor, a touch panel, or the like, for example, as illustrated in FIG. 17A In this case, by selecting store clerk S1 button as illustrated in FIG. 17B, the time (here, conversation start time) when store clerk S1 talk is selectively displayed, and as the user selects a desired time, voice data of store clerk S1 can be extracted from voice data storage unit 33.

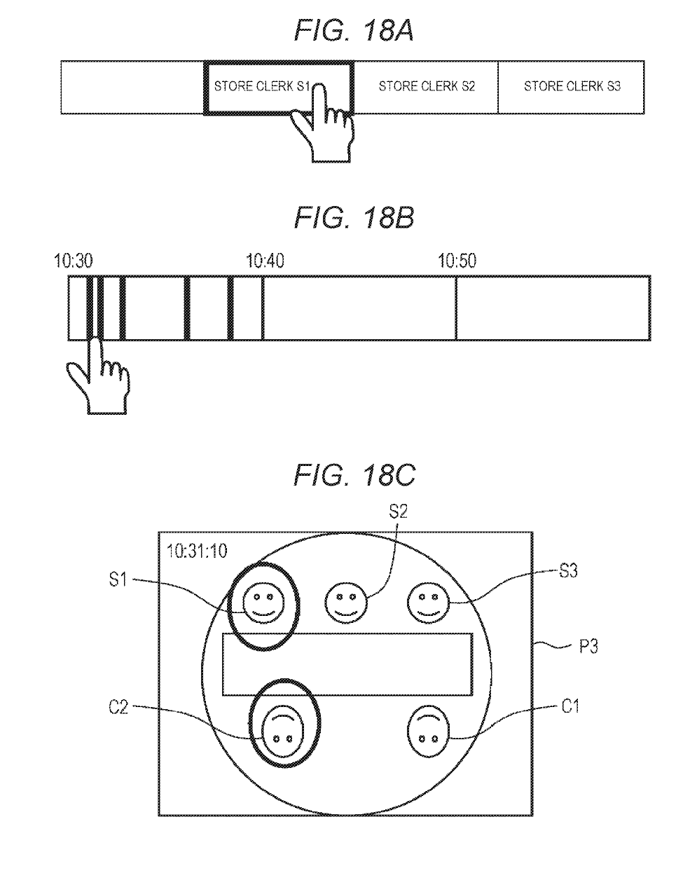

In addition, in step ST401, the user selects a store clerk selection button in the same manner as illustrated in FIG. 17A, for example, as illustrated in FIG. 18A, and thereby, a configuration may be provided in which a table of time when the time zone in which the conversation is made is selectively displayed (here, displayed by a vertical line with a predetermined width) is displayed as illustrated in FIG. 18B In this case, if the user selects a desired time zone as illustrated in FIG. 18B, an image frame P3 at the corresponding time is displayed as illustrated in FIG. 18C, and voice data of the selected store clerk and the customer of the conversation partner can be extracted from voice data storage unit 33.

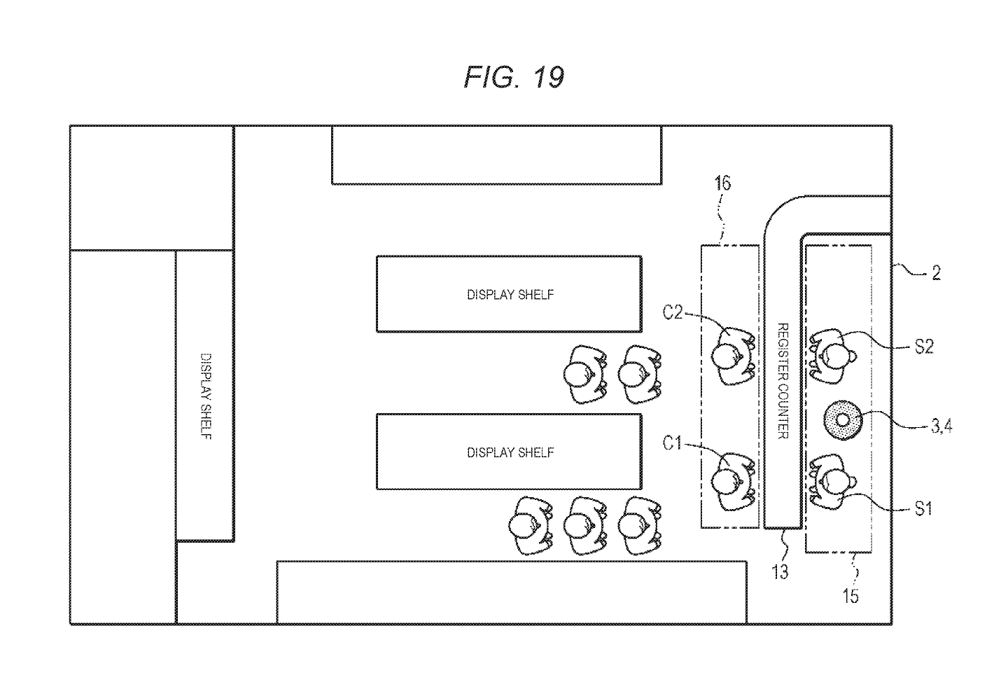

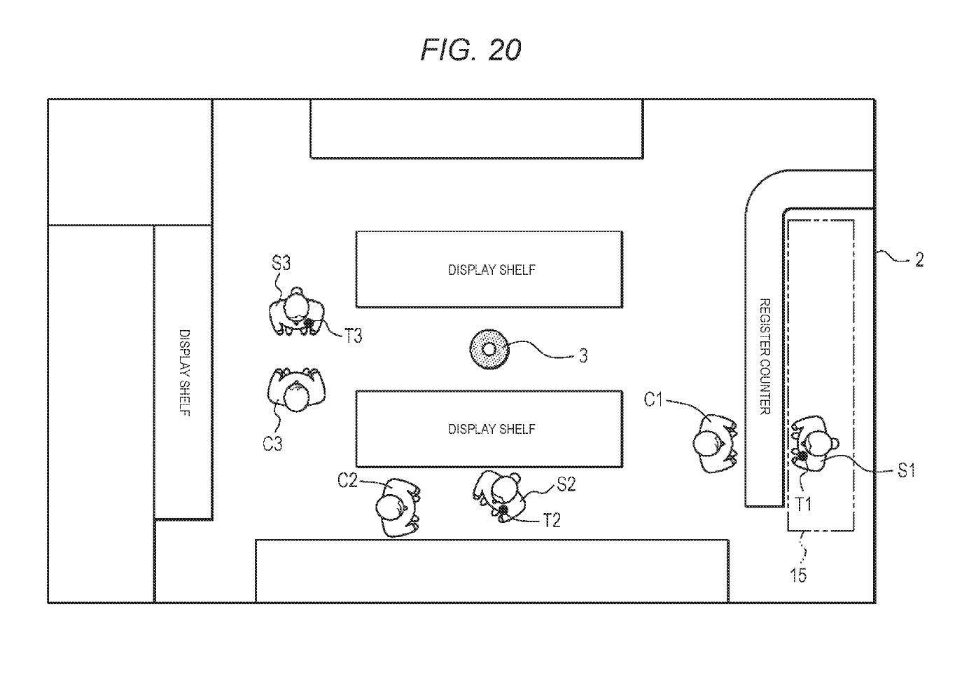

FIG. 19 and FIG. 20 are respectively explanatory diagrams illustrating second and third application examples of customer service monitoring system 1 FIG. 2 illustrates a case where customer service monitoring system 1 is applied to store 2 that provides food and drink in a self-service manner, but the present invention is not limited to this, and customer service monitoring system 1 may be applied to, for example, store 2 of a convenience store illustrated in FIG. 19 In this case, store clerks S1 and S2 are located on the back side of register counter 13, and customers C1 and C2 at the head of each row pay for the purchased merchandise.

In addition, customer service monitoring system 1 can also have a configuration in which tags T1, T2, and T3 are respectively attached to store clerks S1-S3 (clothing or the like) as identification marks, for example, as illustrated in FIG. 20 Thereby customer service person extractor 22 detects tags T1, T2, and T3 in the image frame through image processing, regardless of movement range 15 (that is, store clerk area 26) of the store clerk, thereby extracting each person as store clerks S1-S3 In addition, in the example illustrated in FIG. 20, the entire area of store 2 can be set as a movement range (that is, customer area 27) of the customer Tags T1, T2, and T3 are not limited to those capable of recognizing an image, and may be able to be recognized by a known sensors or the like.

As such, the present invention is described based on specific exemplary embodiments, the exemplary embodiments are merely examples, and the present invention is not limited to the exemplary embodiments For example, the customer service monitoring system according to the aforementioned exemplary embodiment is configured to output (that is, a person confirms voice) the extracted voice data from a speaker or the like, but the present invention is not limited to this, and customer service attitudes may be evaluated by performing known evaluation processing (for example, keyword detection related to upsell talk, conversation ratio detection, or the like) for the extracted voice data Each configuration elements of the customer service monitoring device, the customer service monitoring system, and he customer service monitoring method according to the present invention described in the above exemplary embodiments are not necessarily essential, and can be appropriately selected at least within a range without departing from the scope of the present invention.

A customer service monitoring device, a customer service monitoring system, and a customer service monitoring method according to the present invention can easily monitor a conversation between a desired customer service person and a customer service partner, even in a case where a correspondence relationship between the customer service person and the customer service partner or a position where the conversation is made changes, and is useful as a customer service monitoring device, a customer service monitoring system, a customer service monitoring method, and the like for monitoring customer service attitudes of the customer service persons based on voices when providing customer service.

### REFERENCE MARKS IN THE DRAWINGS

1 customer service monitoring system
2 store
3 camera (image input device)
4 microphone (voice input device)
5 customer service monitoring device
6 communication line
7 relay device
8 wide area network
9 headquarter management device
11 entrance
12 sales counter
13 register counter
movement range of store clerk
16 movement range of customer
user input unit
21 image input unit
22 customer service person extractor
23 customer service partner extractor
24 customer service list generator
25 customer service list storage unit (image data storage unit)
26 store clerk area
27 customer area
31 voice input unit
32 voice data generator
33 voice data storage unit
41 monitoring processor (voice data extractor)
42 voice output unit
43 image output unit
C0,C1,C2,C3 customer
S0,S1,S2,S3 store clerk

1. A customer service monitoring device for monitoring customer service attitude of a customer service person, based on voice when providing customer service, the device comprising:
a voice input unit to which voice of conversation between the customer service person and a customer service recipient thereof is input as a voice signal;
a voice data storage unit in which voice data based on the voice signal is linked with acquisition position data related to a position where the voice is acquired and time data related to time when the voice is acquired and is stored;
an image input unit to which a captured image that is obtained by capturing the customer service person and the customer service recipient is input as an image signal;
a customer service person extractor that acquires customer service person position data by extracting the customer service person from the captured image and provides identification information to the customer service person;
a customer service recipient extractor that acquires customer service recipient position data by extracting the customer service recipient from the captured image and provides identification information to the customer service recipient; and
a voice data extractor which extracts identification information of all of the customer service persons corresponding to the identification information of the customer service recipient designated from a user, based on a customer service list in which identification information of the customer service recipient and identification information of all of the customer service persons who provide customer service to the customer service recipient and time of conversation between the customer service recipient and each of the customer service persons are associated, acquires the customer service person position data corresponding to the extracted identification information of all of the customer service persons, and extracts voice data is linked with the acquisition position data corresponding to each of the acquired customer service person position data from the voice data stored in the voice data storage unit in the order of the time of conversation.

2. The customer service monitoring device of claim 1, wherein the voice data extractor extracts identification information of all of the customer service recipients corresponding to identification information of the customer service person designated from a user on the basis of the customer service list, acquires the customer service recipient position data corresponding to the extracted identification information of all of the customer service recipients, and extracts voice data is linked with the acquisition position data corresponding to each of the acquired customer service recipient position data from the voice data stored in the voice data storage unit in the order of the time of conversation.

3. The customer service monitoring device of claim 1, further comprising:
an image output unit that outputs the captured image,
wherein the customer service person is designated by the user or the customer service recipient is designated by the user from the captured image which is output by the image output unit.

4. The customer service monitoring device of claim 1, wherein the customer service recipient extractor acquires distances between the respective customer service persons extracted by the customer service person extractor and the customer service recipient extracted from the captured image, respectively, and associates the customer service recipient based on a magnitude of the distance with any one of the customer service persons.

5. A customer service monitoring system comprising:
a customer service monitoring device according to claim 1;
a voice input device which inputs each voice of conversations between the respective customer service persons and customer service recipients thereof to the customer service monitoring device as a voice signal; and
an image input device which inputs a captured image that is obtained by capturing the customer service person and the customer service recipient to the customer service monitoring device as an image signal.

6. A customer service monitoring method of an information processing device which monitors customer service attitude of a customer service person, based on voice when providing customer service, the method comprising:
a voice inputting step of inputting voice of conversation between the customer service person and a customer service recipient thereof as a voice signal;
a voice data storing step of linking voice data based on the voice signal with acquisition position data related to a position where the voice is acquired and time data related to time when the voice is acquired and storing the data;
an image input step of inputting a captured image that is obtained by capturing the customer service person and the customer service recipient as an image signal;
a customer service person extracting step of acquiring customer service person position data by extracting the customer service person from the captured image and providing identification information to the customer service person;
a customer service recipient extracting step of acquiring customer service recipient position data by extracting the customer service recipient from the captured image and providing identification information to the customer service recipient; and
a voice data extracting step of extracting identification information of all of the customer service persons corresponding to the identification information of the customer service recipient designated from a user, based on a customer service list in which identification information of the customer service recipient and identification information of all of the customer service persons who provide customer service to the customer service recipient and time of conversation between the customer service recipient and each of the customer service persons are associated, acquiring the customer service person position data corresponding to the extracted identification information of all of the customer service persons, and extracting voice data is linked with the acquisition position data corresponding to each of the acquired customer service person position data from the voice data stored in the voice data storage unit in the order of the time of conversation.
